(19) United States
(12) Patent Application Publication
(10) Pub. No.: US 2025/0298442 A1
(43) Pub. Date: Sep. 25, 2025

(54) DISPLAY APPARATUS, ATTACHING SYSTEM AND ATTACHING METHOD

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Chao ZHOU, Beijing (CN); Yongchun JIANG, Beijing (CN); Liqiang CHEN, Beijing (CN); Mengyuan PANG, Beijing (CN); Yang YANG, Beijing (CN); Yaming WANG, Beijing (CN); Chao YANG, Beijing (CN); Jiafan SHI, Beijing (CN); Zuojia WANG, Beijing (CN); Yanxin WANG, Beijing (CN); Qingsong WANG, Beijing (CN)

(21) Appl. No.: 18/020,780

(22) PCT Filed: Jul. 30, 2021
(86) PCT No.: PCT/CN2021/109888

§ 371 Date: Jun. 30, 2023

(51) Int. Cl. G06F 1/16; B32B 37/00; B32B 38/18

(52) U.S. Cl. CPC G06F 1/1656; B32B 37/187; B32B 38/1841; B32B 2457/20

(57) ABSTRACT

A display apparatus, an attaching system and an attaching method. The display apparatus comprises a cover plate (2), a display panel (1) and a supporting plate (3). The cover plate (2) comprises a first flat surface portion (21), a second flat surface portion (22) and a first curved surface portion (23), wherein the first curved surface portion (23) is smoothly connected between the first flat surface portion (21) and the second flat surface portion (22); the second flat surface portion (22) is parallel to the first flat surface portion (21); the first curved surface portion (23) extends in a first direction; an orthographic projection of the first curved surface portion (23) on a first reference plane is arc-shaped; the first reference plane is perpendicular to an extension direction of the first curved surface portion (23); and an accommodating space is formed by means of the enclosure of the first flat surface portion (21), the second flat surface portion (22) and the first curved surface portion (23). The display panel (1) is arranged in the accommodating space. The supporting plate (3) comprises a first straight supporting portion (3a), a first cambered surface supporting portion (3b) and a second straight supporting portion (3c), which are sequentially connected; the modulus of the first cambered surface supporting portion (3b) is smaller than that of the first straight supporting portion (3a) and is also smaller than that of the second straight supporting portion (3c); the first straight supporting portion (3a) is attached to the side of the display panel (1) away from the first flat surface portion (21); the first cambered surface supporting portion (3b) is attached to the side of the display panel (1) away from the first curved surface portion (23); and the second straight supporting portion (3c) is attached to the side of the display panel (1) away from the second flat surface portion (22). The supporting plate (3) has enough strength to support the display panel (1), and the supporting plate (3) has enough flexibility so as not to be prone to warping and bulging when being bent, thereby preventing the display panel from warping and bulging.

### CROSS-REFERENCE TO RELATED APPLICATIONS

The present application is the U.S. National phase application of International Application No. PCT/CN2021/109888, filed on Jul. 30, 2021, the entire contents of which are hereby incorporated by reference in its entirety.

### TECHNICAL FIELD

The present disclosure relates to the field of display technology, and particularly, to a display device, and a lamination system and a lamination method for a lamination of the display device.

### BACKGROUND

At present, with the rapid development of Organic Light-Emitting Diode (OLED) technology, OLED display products of various shapes are gradually emerging in pursuit of maximizing mobile phone screens. The currently double-sided OLED screen (or called surrounded-shaped OLED screen) has the highest screen-to-body ratio, and its screen-to-body ratio may reach more than 180%. However, the lamination between the cover plate of the double-sided OLED screen and the display panel is a technical difficulty.

It is noted that the above information disclosed in the background section is only for enhancing understanding of the background of the present disclosure, and therefore may include information that does not constitute the prior art known to those ordinary skilled in the art.

### SUMMARY

The present disclosure provides a display device, and a lamination system and a lamination method for a lamination of the display device.

According to a first aspect of the present disclosure, there is provided a display device, including:

a cover plate, including at least a first planar portion, a second planar portion and a first curved portion, where the first curved portion is smoothly connected between the first planar portion and the second planar portion; the second planar portion is parallel to the first planar portion; the first curved portion extents along a first direction, and an orthographic projection of the first curved portion on a first datum plane is an arc, the first datum plane being perpendicular to the first direction; and the first planar portion, the second planar portion and the first curved portion enclose an accommodation space;

a display panel in the accommodation space; and

a support plate, including at least a first straight support portion, a first cambered support portion and a second straight support portion connected in sequence, where the modulus of the first cambered support portion is less than the modulus of the first straight support portion, and the modulus of the first cambered support portion is less than the modulus of the second straight support portion;

where the first straight support portion is laminated to one side of the display panel away from the first planar portion, the first cambered support portion is laminated to one side of the display panel away from the first curved portion, and the second straight support portion is laminated to one side of the display panel away from the second planar portion.

According to a second aspect of the present disclosure, there is provided a lamination system for a lamination of the display device according to the first aspect, and the lamination system includes:

a stage, configured to fix a cover plate;

a carrier film, configured to laminate a support plate and a display panel in sequence;

a clamp portion, configured to clamp two opposite ends of the carrier film;

a slider, the carrier film surrounding outside the slider; and

a mechanical arm, with one end connected to the slider, where the mechanical arm is configured to drive the slider to move so that the display panel is laminated to the cover plate.

According to a third aspect of the present disclosure, there is provided a lamination method in which the display device according to the first aspect is formed by laminating with the lamination system according to the second aspect, and the lamination method includes:

adhering a support plate and a display panel in sequence on one surface of a carrier film, and forming a first adhesive layer on one side of the display panel away from the carrier film;

surrounding the carrier film outside a slider, and clamping, by a clamp portion, two opposite ends of the carrier film for profiling of the display panel;

driving, by a mechanical arm, the slider to move along a third direction to an accommodation space of a cover plate;

driving, by the mechanical arm, the slider to move along a fourth direction, so that the display panel is in contact with a first curved portion, and driving, by the mechanical arm, the slider to slide along the first curved portion to complete the lamination between the display panel and the first curved portion; and

driving, by the mechanical arm, the slider to move along a direction perpendicular to the first planar portion to complete the lamination between the display panel and the first planar portion or between the display panel and the second planar portion.

It should be understood that the foregoing general description and the following detailed description are exemplary and explanatory only and cannot limit the present disclosure.

### BRIEF DESCRIPTION OF THE DRAWINGS

The accompanying drawings, which are incorporated in and constitute a part of the specification, illustrate embodiments consistent with the present disclosure, and serve to explain the principle of the present disclosure together with the description. Obviously, the drawings in the following description are only some embodiments of the present disclosure, and for those ordinary skilled in the art, other drawings may also be obtained from these drawings without creative effort.

FIG. 1 is a schematic structural diagram of a display panel after profiling in the related art.

FIG. 2 is a schematic structural diagram of a display device according to a first exemplary embodiment of the present disclosure.

FIG. 3 is a schematic structural diagram of a cover plate in FIG. 2.

FIG. 4 is a schematic structural diagram of a support plate in FIG. 2.

FIG. 5 is a schematic structural diagram of the support plate and a display panel in

FIG. 4 after profiling.

FIG. 6 is a schematic structural diagram of a cover plate in a display device according to a second exemplary embodiment of the present disclosure.

FIG. 7 is the schematic top view of FIG. 6.

FIG. 8 is a schematic structural diagram of a support plate in a display device according to the second exemplary embodiment of the present disclosure.

FIG. 9 is a schematic structural diagram of a cover plate in a display device according to a third exemplary embodiment of the present disclosure.

FIG. 10 is a schematic structural diagram of a support plate in a display device according to the third exemplary embodiment of the present disclosure.

FIG. 11 is a structural diagram of the cover plate and the support plate in the display device according to second exemplary embodiment of the present disclosure after profiling.

FIG. 12 is a schematic structural diagram of the cover plate and the support plate in the display device according to the third exemplary embodiment of the present disclosure after profiling.

FIG. 13 is a schematic flow chart of a lamination method according to an exemplary embodiment of the present disclosure.

FIG. 14 is a schematic structural diagram illustrating a step of a lamination process of a display device according to the first exemplary embodiment of the present disclosure.

FIG. 15 is a schematic structural diagram illustrating a step of a lamination process of a display device according to the first exemplary embodiment of the present disclosure.

FIG. 16 is a schematic structural diagram illustrating a step of a lamination process of a display device according to the first exemplary embodiment of the present disclosure.

FIG. 17 is a schematic structural diagram illustrating a step of a lamination process of a display device according to the second exemplary embodiment of the present disclosure.

FIG. 18 is a schematic structural diagram illustrating a step of a lamination process of a display device according to the second exemplary embodiment of the present disclosure.

FIG. 19 is a schematic structural diagram illustrating a step of a lamination process of a display device according to the second exemplary embodiment of the present disclosure.

FIG. 20 is a schematic structural diagram illustrating a step of a lamination process of a display device according to the second exemplary embodiment of the present disclosure.

FIG. 21 is a schematic structural diagram illustrating a step of a lamination process of a display device according to the second exemplary embodiment of the present disclosure.

FIG. 22 is a schematic structural diagram illustrating a step of a lamination process of a display device according to the second exemplary embodiment of the present disclosure.

FIG. 23 is a schematic structural diagram illustrating a step of a lamination process of a display device according to the third exemplary embodiment of the present disclosure.

FIG. 24 is a schematic structural diagram illustrating a step of a lamination process of a display device according to the third exemplary embodiment of the present disclosure.

FIG. 25 is a schematic structural diagram illustrating a step of a lamination process of a display device according to the third exemplary embodiment of the present disclosure.

FIG. 26 are schematic structural diagrams of respective steps of a lamination process of the display device according to the third exemplary embodiment of the present disclosure.

### DETAILED DESCRIPTION

Exemplary embodiments will now be described more fully with reference to the accompanying drawings. However, the exemplary embodiments can be implemented in various forms and should not be construed as being limited to the examples set forth here; rather, these embodiments are provided so that this disclosure will be comprehensive and complete, and the concept of exemplary embodiments will be fully conveyed to those skilled in the art. The same reference numerals in the figures represent the same or similar structures, and thus their detailed descriptions will be omitted. Further, the figures are merely schematic illustrations of the present disclosure and are not necessarily drawn to scale.

Although relative terms are used in the present description, for example, “on” and “below” are used to describe the relative relationship of one assembly of a reference number to another assembly, these terms are used in the present description for convenience only, e.g., according to the direction of examples depicted in the figures. It can be appreciated that if the device of a reference number is turned upside down, the assembly described as “above” will become the assembly “below”. When a structure is “on” other structures, it may mean that the structure is integrally formed on other structures, or that the structure is “directly” provided on other structures, or that the structure is “indirectly” provided on other structures through another structure.

The terms “a”, “an”, “the”, “said” and “at least one” are used to indicate the presence of one or more elements/components/etc. The terms “comprise” and “include” are used to indicate an open-ended inclusion and mean that additional elements/components/etc. may be present in addition to listed elements/components/etc. The terms “first”, “second”, “third” and the like are used as tags only and are not intended to limit the number of objects after them.

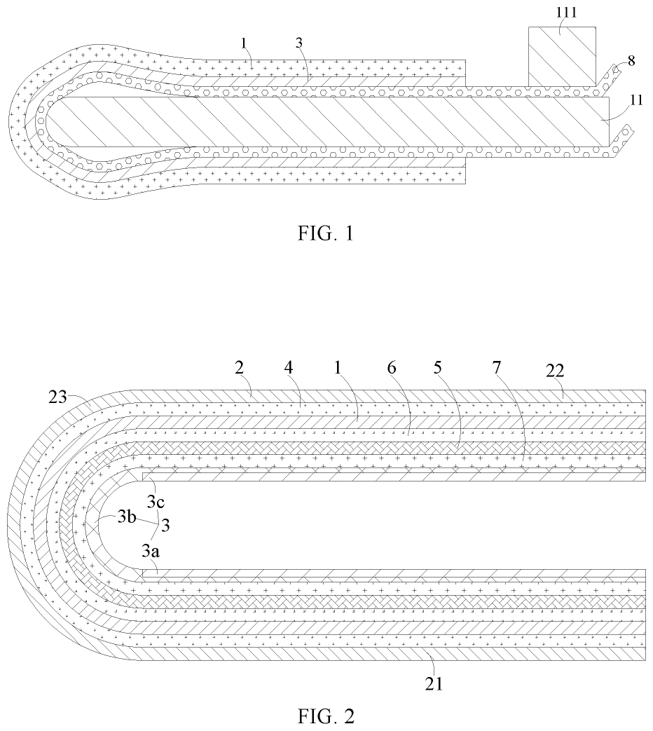

Referring to FIGS. 1 and 2, before a cover plate 2 is laminated to a display panel 1, a non-display surface of the display panel 1 may usually be laminated onto a support plate 3, and then the support plate 3 is laminated onto a carrier film 8 (the length of the carrier film 8 is greater than the length of the display panel 1); and pull is applied to both ends of the carrier film 8, and then a part of the carrier film 8 is surrounded on a slider 11, so that the carrier film 8, the support plate 3 and the display panel 1 form a shape similar to the outer contour of the slider 11, for example, in the arc region of the slider 11, the carrier film 8, the support plate 3 and the display panel 1 all form arcs. The aforementioned process is called profiling. In this process, since the display panel 1 and the support plate 3 have certain rebound force effect in the arc region of the slider 11, the display panel 1 and the support plate 3 may warp and bulge to a certain extent, so that there is a relatively large gap between the display panel 1 and the slider 11, and distance between two opposite planar portions of the display panel increases after profiling, but the height of the space of the cover plate 2 for accommodating the display panel 1 may not change, resulting in the slider 11 being unable to successfully drive the carrier film 8, the support plate 3 and the display panel 1 to enter into the accommodation space of the cover plate 2. Moreover, it is not easy to laminate the cover plate 2 with the display panel 1 when the slider 11 drives the display panel 1 to move in the lamination process, and in the lamination process of the cover plate 2 and the display panel 1, bubbles are easily generated and wrinkles may be produced.

An exemplary embodiment of the present disclosure provides a display device, and referring to FIG. 2, the display device may include the cover plate 2, the display panel 1 and the support plate 3. The cover plate 2 includes at least a first planar portion 21, a second planar portion 22 and a first curved portion 23. The first curved portion 23 is smoothly connected between the first planar portion 21 and the second planar portion 22. The second planar portion 22 is parallel to the first planar portion 21. The first curved portion extends along a first direction, and an orthographic projection of the first curved portion 23 on a first datum plane is an arc. The first datum plane is perpendicular to the first direction. The first planar portion 21, the second planar portion 22 and the first curved portion 23 enclose an accommodation space. The display panel 1 is provided in the accommodation space. The support plate 3 includes at least a first straight support portion 3a, a first cambered support portion 3b and a second straight support portion 3c connected in sequence. The modulus of the first cambered support portion 3b is less than the modulus of the first straight support portion 3a, and the modulus of the first cambered support portion 3b is less than the modulus of the second straight support portion 3c. The first straight support portion 3a is laminated to one side of the display panel 1 away from the first planar portion 21, the first cambered support portion 3b is laminated to one side of the display panel 1 away from the first curved portion 23, and the second straight support portion 3c is laminated to one side of the display panel 1 away from the second planar portion 22.

In the display device of the present disclosure, the modulus of the first cambered support portion 3b is less than the modulus of the first straight support portion 3a, and the modulus of the first cambered support portion 3b is less than the modulus of the second straight support portion 3c; and the first straight support portion 3a is laminated to one side of the display panel 1 away from the first planar portion 21, the second straight support portion 3c is laminated to one side of the display panel 1 away from the second planar portion 22, so that the support plate 3 have sufficient strength to achieve the effect of supporting the display panel 1. The first cambered support portion 3b is laminated to one side of the display panel 1 away from the first curved portion 23, causing the support plate 3 to have sufficient flexibility to prevent the support plate 3 from warping and bulging easily during bending, so that warping and bulging of the display panel 1 is avoided, the distance between two opposite planar portions of the display panel 1 may not increase after profiling, and the slider 11, the carrier film 8, the support plate 3 and the display panel 1 can successfully enter into the cover plate 2. Moreover, the display panel 1 and the slider 11 are tightly laminated, so that it is easy for the cover plate 2 to be laminated with the display panel 1 when the slider 11 drives the display panel 1 to move in the lamination process, and in the lamination process of the cover plate 2 and the display panel 1, bubbles are not easily generated nor wrinkles may be produced.

The cover plate 2 may be a surround-shaped cover plate 2.

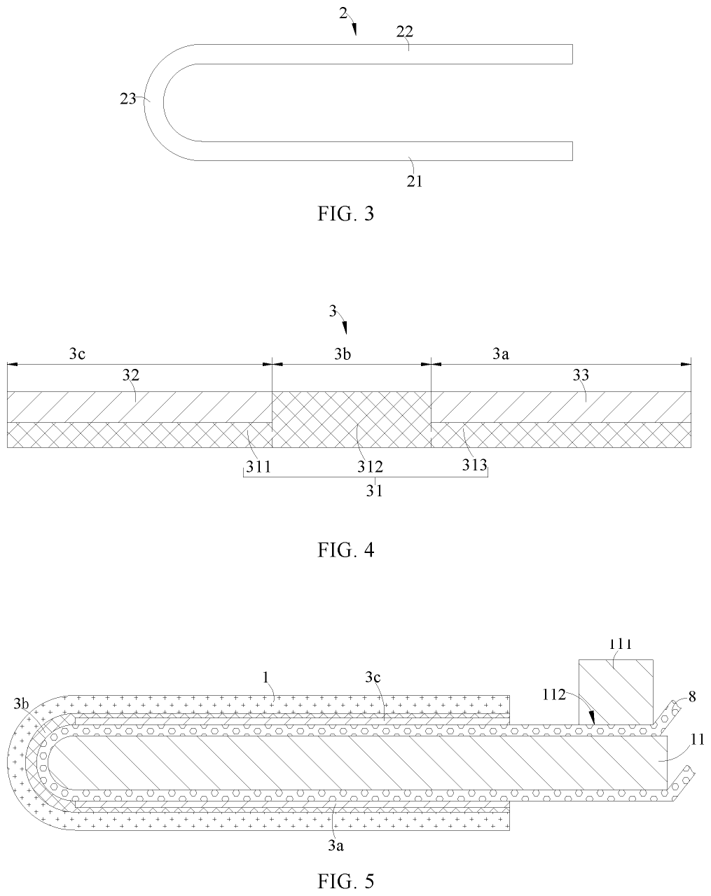

The present exemplary embodiment, referring to FIG. 3, the cover plate 2 may include the first planar portion 21, the first curved portion 23 and the second planar portion 22. The first planar portion 21, the first curved portion 23 and the second planar portion 22 are connected in sequence to form a “U” shape.

Specifically, the first planar portion 21 may be provided in rectangle and the first planar portion 21 may include a first plane and a second plane oppositely disposed. The first curved portion 23 is smoothly connected to one side of the first planar portion 21, for example, the first curved portion 23 may smoothly connected to a long side of the first planar portion 21, so that the first curved portion 23 extents along the long side of the first planar portion 21. Of course, in other exemplary embodiments of the present disclosure, the first curved portion 23 may smoothly connected to a short side of the first planar portion 21, so that the first curved portion 23 extents along the short side of the first planar portion 21. The first planar portion 21 may also be provided in other shapes. The extending direction of the first curved portion 23 is consistent with the extending direction of an edge of the first planar portion 21 which is an edge of the first planar portion 21 and is connected with the first curved portion 23. The first curved portion extents along the first direction, and the first direction is the extending direction of the axis corresponding to the cambered surface formed by the first curved portion.

The orthographic projection of the first curved portion 23 on the first datum plane is an arc, for example, a semi-circular arc, a semi-elliptical arc, a parabolic arc, etc. The first datum plane is perpendicular to the extending direction of the first curved portion, i.e., the first datum plane is perpendicular to the first direction. That is, the first datum plane is perpendicular the foregoing edge which is the edge of the first planar portion 21 and is connected with the first curved portion 23. Specifically, the first curved portion 23 may include a first curved surface and a second curved surface oppositely disposed. An orthographic projection of the first curved surface on the first datum plane is a semi-circular arc line, and an orthographic projection of the second curved surface on the first datum plane is also a semi-circular arc line. The two semi-circular arc lines are parallel to each other, and the two semi-circular arc lines are connected to form a semi-circular arc.

The first curved surface is connected to the first plane, and the first curved surface is tangent to the first plane. The second curved surface is connected to the second plane, and the second curved surface is tangent to the second plane. In this way, the first curved portion 23 is smoothly connected to the first planar portion 21.

The second planar portion 22 may also be provided in rectangle. The second planar portion 22 is smoothly connected to the other opposite side of the first curved portion 23, and the second planar portion 22 is parallel with the first planar portion 21. The second planar portion 22 may include a third plane and a fourth plane oppositely disposed. The third plane may be connected to the first curved surface, and the first curved surface is tangent to the third plane. The fourth plane is connected to the second curved surface, and the second curved surface is tangent to the fourth plane. In this way, the first curved portion 23 is smoothly connected to the second planar portion 22.

In the present exemplary embodiment, the width of the second planar portion 22 may be equal to the width of the first planar portion 21. The length of the first curved portion 23 and the length of the second planar portion 22 may be equal to the length of the first planar portion 21. Of course, in other exemplary embodiments of the present disclosure, the width of the second planar portion 22 may be different from the width of the first planar portion 21, and the length of the first curved portion 23 and the length of the second planar portion 22 may be different from the length of the planar portion 21.

It should be noted that, referring to FIG. 7, the length direction Y is the direction consistent with the extending direction of the first curved portion 23, and the width direction X is the direction perpendicular to the extending direction of the first curved portion 23. Of course, the thickness direction Z is also perpendicular to the extending direction of the first curved portion 23, but the thickness direction Z is consistent with the direction of the separation distance between the first planar portion 21 and the second planar portion 22. The length direction Y is the first direction, and the width direction X is the second direction.

Continuing to refer to FIG. 2, the display panel 1 is provided in the accommodation space of the cover plate 2. The portion of the display panel 1 corresponding to the first planar portion 21 is a first planar region, the portion of the display panel 1 corresponding to the first curved portion 23 is a curved region, and the portion of the display panel 1 corresponding to the second planar portion 22 is a second planar region. Since the first planar portion 21 is parallel to the second planar portion 22, the first planar region of the display panel 1 is also parallel to the second planar region of the first planar region. Moreover, since the width of the second planar portion 22 is equal to the width of the first planar portion 21, the width of the first planar region of the display panel 1 is also equal to the width of the second planar region of the first planar region.

The display surface of the display panel 1 is laminated to the inner surface of the cover plate 2, and specifically, the display surface of the display panel 1 is laminated to the inner surface of the cover plate 2 though a first adhesive layer 4. The first adhesive layer 4 may be an optically clear adhesive (OCA).

It should be noted that, the accommodation space of the cover plate 2 refers to a semi-enclosing structure formed by connecting the first curved portion 23 with the first planar portion 21 and the second planar portion 22 at one side where the center of a circle of the first curved portion 23 is located, and the accommodation space of the semi-enclosing structure is the accommodation space of the cover plate 2.

The support plate 3 is provided on one side of the display panel 1 away from the cover plate 2, i.e., the support plate 3 is provided on one side of the display panel 1 opposite to the display surface. The support plate 3 supports the display panel 1.

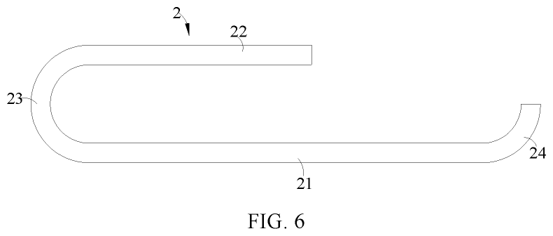

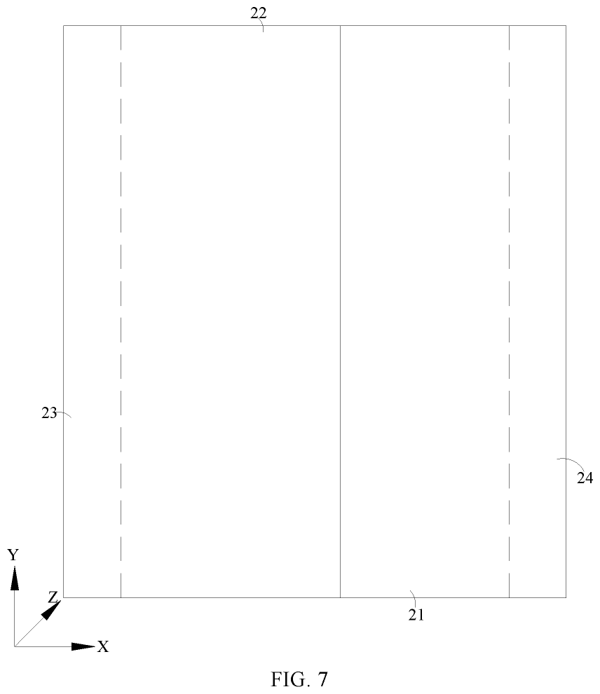

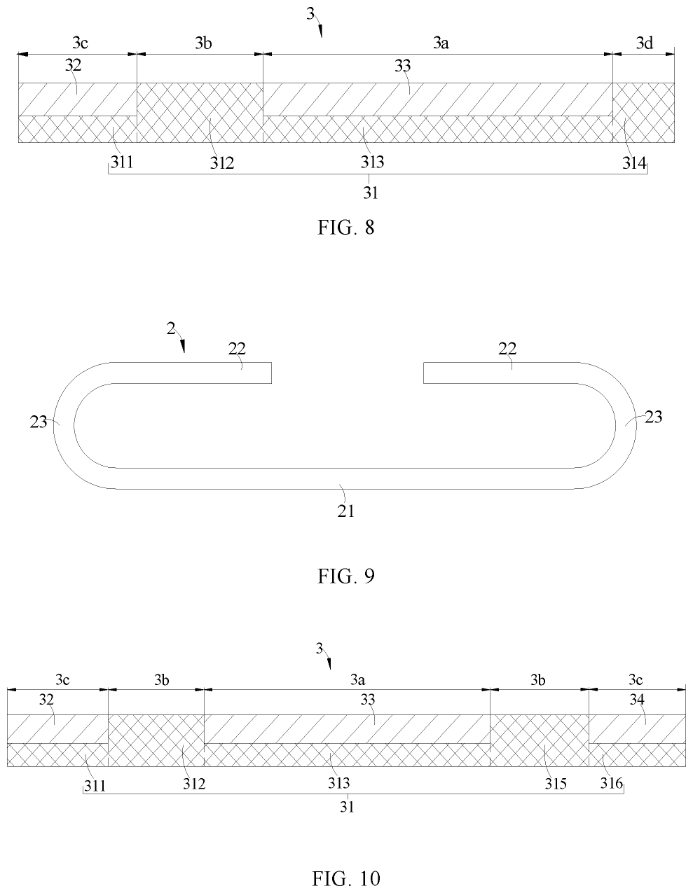

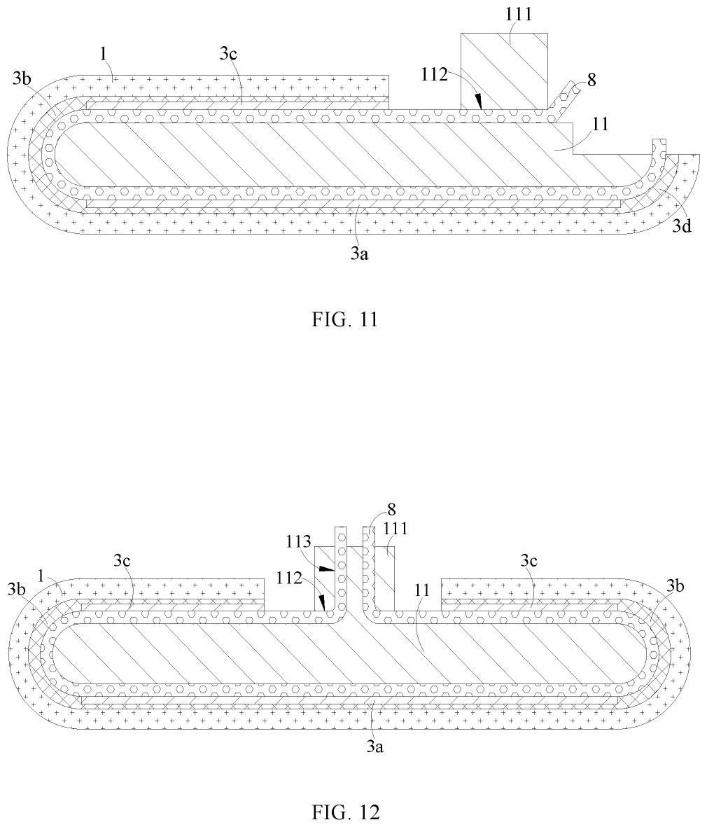

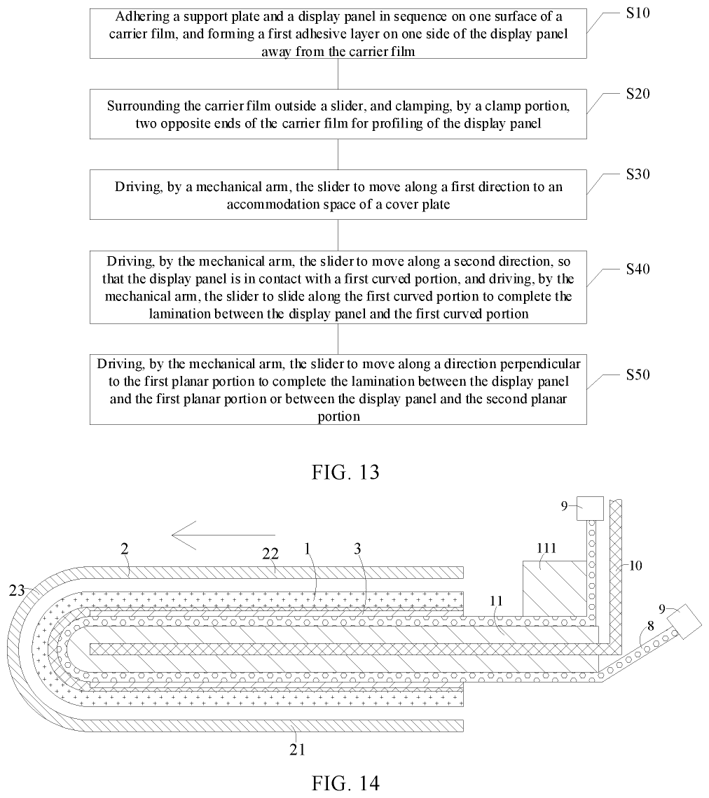

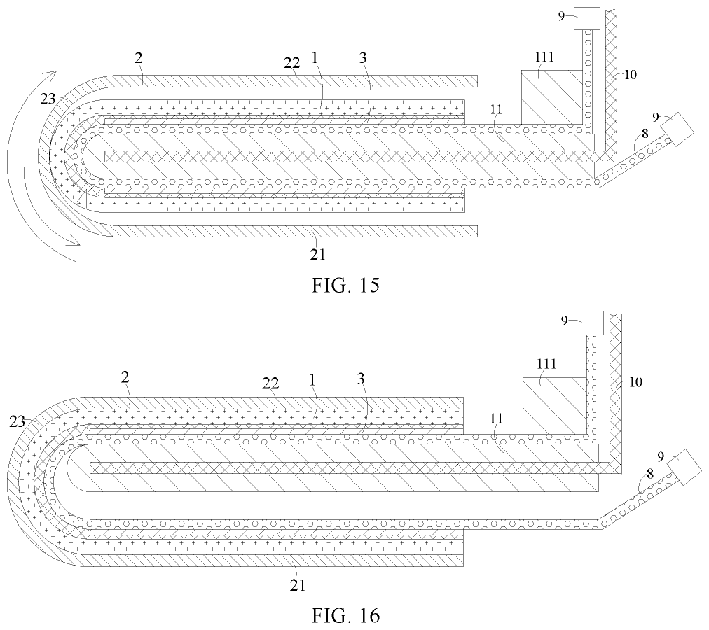

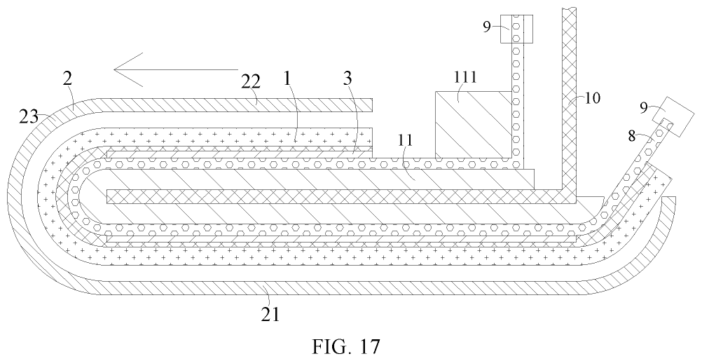

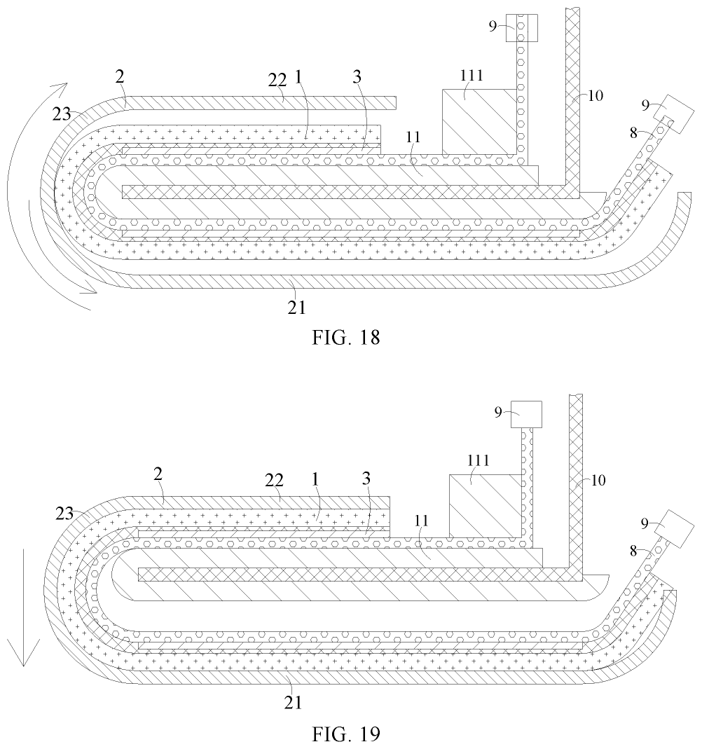

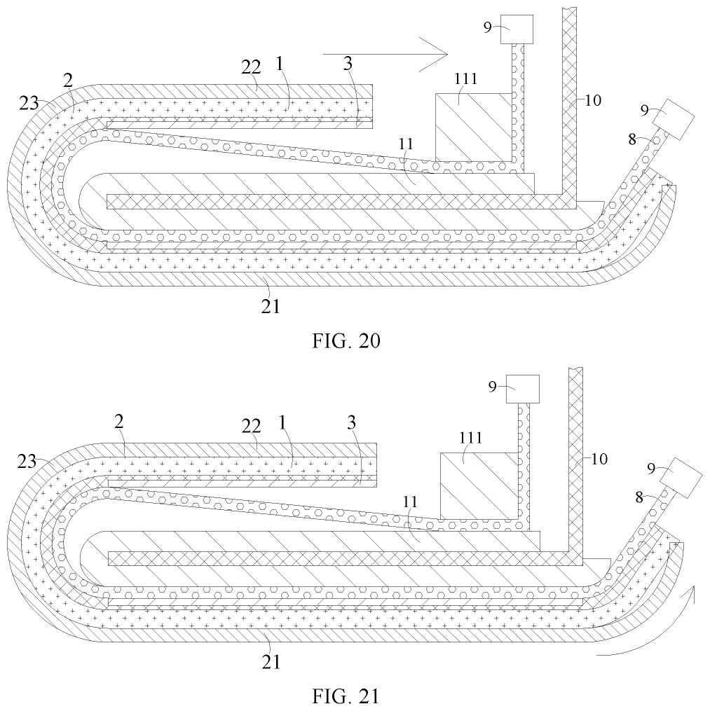

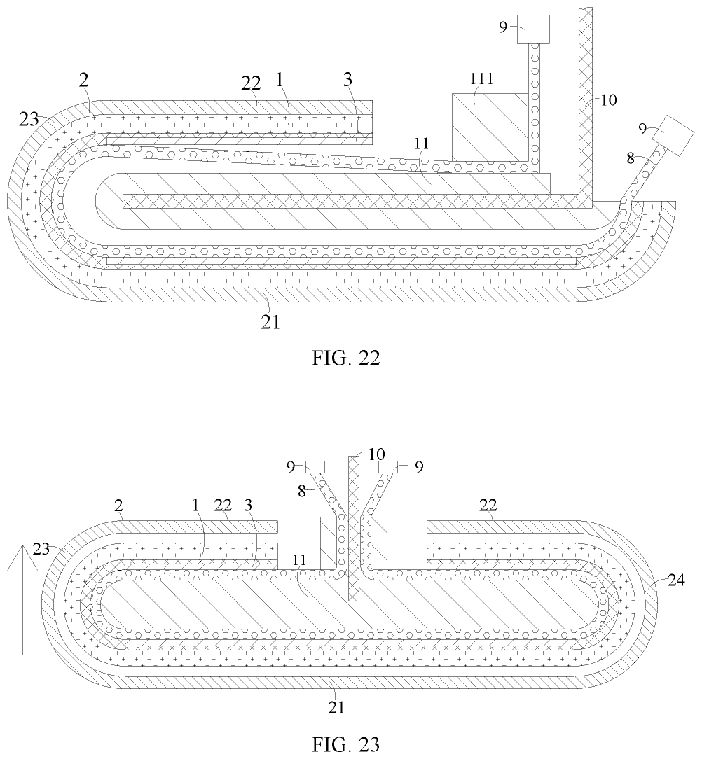

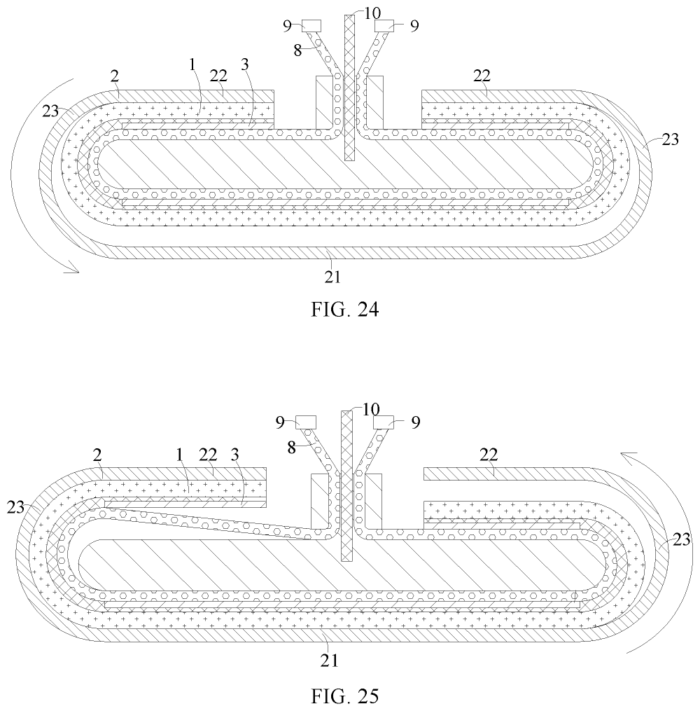

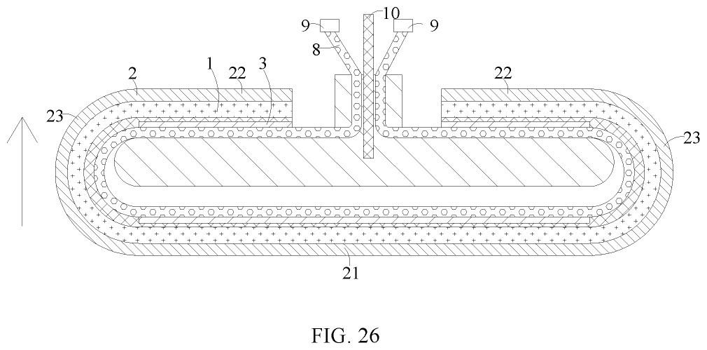

Specifically, referring to FIGS. 4 and 5, the support plate 3 may include a first layer 31, a second layer 32 and a third layer 33. The first layer 31 is provided on one side of the display panel 1 away from the cover plate, the second layer 32 is provided on one side of the first layer 31 away from the cover plate, and the second layer 32 is also provided on one side of the first layer 31 away from the cover plate.

Specifically, the first layer 31 may include a first part 311, a second part 312 and a third part 313 connected in sequence. The second part 312 forms the first cambered support portion 3b, and the second part 312 is laminated to one side of the display panel 1 away from the first curved portion. The thickness of the second part 312 is greater than the thickness of the first part 311, and the thickness of the second part 312 is greater than the thickness of the third part 313. Of course, the thickness the first part 311, the second part 312 and the third part 313 may be equal.

The second layer 32 is provided on one side of the first part 311 away from the display panel 1, and the second layer 32 and the first part 311 form the second straight support portion 3c, i.e., the second straight support portion 3c may include the second layer 32 and the first part 311. The modulus of the first layer 31 is less than the modulus of the second layer 32, so that the modulus of the second straight support portion 3c is greater than the modulus of the first cambered support portion 3b.

The third layer 33 is provided on one side of the third part 313 away from the display panel 1, and the third layer 33 and the third part 313 form the first straight support portion 3a, i.e., the first straight support portion 3a may include the third layer 33 and the third part 313. The modulus of the first layer 31 is less than the modulus of the third layer 33, so that the modulus of the first straight support portion 3a is greater than the modulus of the first cambered support portion 3b. In this way, the support plate 3 has sufficient strength to achieve the effect of supporting the display panel 1, while the support plate 3 corresponding to the first curved portion 23 includes only the second part 312 of the first layer 31 with a relative small modulus, so that the support plate 3 has sufficient flexibility to prevent the support plate 3 from warping and bulging easily, and thus avoiding warping and bulging of the display panel 1.

The thickness of the second part 312 is equal to the sum of the thickness of the first part 311 and the thickness of the second layer 32, and the thickness of the second part 312 is equal to the sum of the thickness of the third part 313 and the thickness of the third layer 33, so that overall thickness of the support plate 3 is consistent, and unevenness of the support plate 3 is avoided.

The thickness of the second layer 32 is equal to or greater than 15 microns and is equal to or smaller than 200 microns, and the thickness of the third layer 33 is equal to or greater than 15 microns and is equal to or smaller than 200 microns. The thickness of the first part 311 and the thickness of third part 313 are equal to or greater than 10 microns and are equal to or smaller than 200 micron, and the thickness of the second part 312 is equal to or greater than 25 microns and is equal to or smaller than 400 microns.

The material of the first layer 31 may be foam, and the material of the second layer 32, the third layer 33 and a fourth layer 34 may be 304 stainless steel (SUS304) plate.

Of course, in other exemplary embodiments of the present disclosure, the thickness of the second part 312 may also be greater or smaller than the sum of the thickness of the first part and the thickness of the second layer 32, and the thickness of the second part 312 may also be greater or smaller than the sum of the thickness of the third part 313 and the thickness of third layer 33. Moreover, the material of the first layer 31 may also be flexible material such as rubber, flexible resin and the like, and the material of the second layer 32 and third layer 33 may also be other components of stainless steel plate, rigid plastic plate and the like.

The second layer 32 and the third layer 33 are provided on one side of the first layer 31 away from the display panel 1, i.e., the first layer 31 in direct contact with the display panel 1. The first layer 31 has certain elasticity, so that the damage to the display panel 1 from the second layer 32 and the third layer 33 is avoided during bending. Moreover, the display panel 1 needs to be powered on when working, so the first layer 31 is generally made of insulating material, the second layer 32 and the third layer 33 are generally made of conductive material, and the first layer 31 can further play an insulating role.

The length of the support plate 3 is equal to or greater than the length of the display panel 1, and the width of the support plate 3 is equal to or greater than the width of the display panel 1.

The length of the second layer 32 and the length of the third layer 33 may be equal to the length of the bending support plate 3, the width of the second layer 32 may be equal to the width of the first planar portion 21, and the width of the third layer 33 may be equal to the width of the second planar portion 22. In addition, in some other exemplary embodiments of the present disclosure, a plurality of second layers 32 may be provided, the second layers 32 are provided in the form of strips, and the plurality of second layers 32 are provided parallel to each other on one side of the first part 311 away from the display panel 1. In this case, the width of a respective second layer 32 is relatively small, and two adjacent second layers 32 may be provided at intervals, or may not be provided at intervals. Of course, similarly, a plurality of third layers 33 may also be provided, the third layers 33 are provided in the form of strips, the plurality of third layers 33 are provided parallel to each other on one side of the third part 313 away from the display panel 1. In this case, the width of a respective third layer 33 is relatively small, and two adjacent third layers 33 may be provided at intervals, or may not be provided at intervals.

In the present exemplary embodiments, continuing to refer to FIG. 2, a protective layer 5 is further provided between the display panel 1 and the support plate 3. The protective layer 5 is adhesively bonded to the display panel through a second adhesive layer 6. The second adhesive layer 6 may be a pressure sensitive adhesive. The protective layer 5 is adhesively bonded to the support plate 3 through a third adhesive layer 7. The third adhesive layer 7 may also be an optically clear adhesive (OCA). The third adhesive layer 7 may play a buffer role between the display panel 1 and the support plate 3, which may reduce the risk of cracks occurring in the display panel 1 in the surround-typed lamination process.

In addition, the structure of the cover plate 2 is not limited to the foregoing description, and in another exemplary embodiment of the present disclosure, referring to FIGS. 6 and 7, the cover plate 2 may further includes a second curved portion 24. The second curved portion 24 is smoothly connected to one side of the first planar portion 21 away from the first curved portion 23. The second curved portion 24 and the first curved portion 23 are bent to the same surface of the first planar portion 21. An orthographic projection of the second curved portion 24 on the first datum plane is an arc, for example, a quarter circular arc or a quarter ellipse arc, a one third of a circular arc or a one third of ellipse arc, etc.

Specifically, the second curved portion 24 may include a third curved surface and a fourth curved surface oppositely disposed. The third curved surface is connected to the first plane, and the third curved surface is tangent to the first plane. The fourth curved surface is connected to the second plane, and the fourth curved surface is tangent to the second plane. In this way, the second curved portion 24 is smoothly connected to the first planar portion 21.

Moreover, the center of a circle of the second curved portion 24 and the center of a circle of the first curved portion 23 are located at the same side of the first planar portion 21, i.e., the second curved portion 24 and the first curved portion 23 are bent to the same surface of the first planar portion 21.

The orthographic projection of the second curved portion 24 on the first datum plane is a quarter circular arc. Specifically, the orthographic projection of the third curved surface on the first datum plane is a quarter circular arc line, and the orthographic projection of the fourth curved surface on the first datum plane is also a quarter circular arc line. The two quarter circular arc lines are parallel to each other, and the two quarter circular arc lines are connected into a quarter circular arc.

Further, in the exemplary embodiment, the width of the second planar portion 22 is smaller than the width of the first planar portion 21, so that cover plate 2 has a sufficient gap to allow a mechanical arm of a lamination system to slide within the gap to complete the lamination process between the cover plate 2 and the display panel.

In this case, among two planar regions and two curved regions formed after the display panel 1 is laminated to the cover plate 2. One planar region is laminated to the first planar portion 21 of the cover plate 2, where the length of the planar region is substantively equal to the length of the first planar portion 21, and the width of the planar region is substantively equal to the width of the first planar portion 21. The other planar region is laminated to the second planar portion 22 of the cover plate 2, where the length of the planar region is substantively equal to the length of the second planar portion 22, and the width of the planar region is substantively equal to width of the second planar portion 22. One curved region is laminated to the first curved portion 23 of the cover plate 2, where the length of the curved region is substantively equal to the length of the first curved portion 23, the width of the curved region is substantively equal to the width of the first curved portion 23, and the curved region is bent to form a semi-circular arc. The other curved region is laminated to the second curved portion 24 of cover plate 2, where the length of the curved region is substantively equal to the length of the second curved portion 24, the width of the curved region is substantively equal to the width of the second curved portion 24, and the curved region is bent to form a quarter circular arc.

Similarly, in order to correspond to the foregoing cover plate 2, referring to FIG. 8, the support plate may further include a second cambered support portion 3d. The second cambered support portion 3d is connected to one side of the first straight support portion 3a away from the first cambered support portion 3b, and the second cambered support portion 3d is laminated to one side of the display panel away from the second curved portion. The modulus of the second cambered support portion 3d is less than the modulus of the first straight support portion 3a, and the modulus of the second cambered support portion 3d is less than the modulus of the second straight support portion 3c.

The support plate may further be provided in structure of a double-plate. The first layer 31 may further include a fourth part 314. The fourth part 314 is connected to the third part 313 and the fourth part 314 forms the second cambered support portion 3d. The thickness of the fourth part 314 is equal to the thickness of the second part 312, i.e., the thickness of the fourth part 314 may be equal to or greater than 25 microns and be equal to or smaller than 300 microns.

Specifically, the support plate may include the first layer 31, the second layer 32 and the third layer 33. The first layer 31 includes the first part 311, the second part 312, the third part 313 and the fourth part 314 interconnected. The thickness of the second part 312 is equal to the thickness of the fourth part 314, and the thickness of the first part 311 is equal to the thickness of the third part 313. The thickness of the first part 311 is less than the thickness of the second part 312.

The second part 312 forms the first cambered support portion 3b, and is laminated to one side of the display panel away from the first curved portion. The fourth part 314 forms the second cambered support portion 3d, and is laminated to one side of the display panel away from the second curved portion. The second layer 32 is provided on one side of the first part 311 away from the display panel, the first part 311 and the second layer 32 form the second straight support portion 3c, the first part 311 is laminated to one side of the display panel away from the second planar portion, and the second layer 32 is laminated to one side of the first part 311 away from the second planar portion. The third layer 33 is provided on one side of the third part 313 away from the display panel, the third part 313 and the third layer 33 form the first straight support portion 3a, the third part 313 is laminated to one side of the display panel away from the first planar portion, and the third layer 33 is laminated to one side of the third part 313 away from the first planar portion.

The width of the first part 311 is less than the width of the third part 313, and the width of the second layer 32 is less than the width of the third layer 33.

In still another exemplary embodiment of the present disclosure, referring to FIG. 9, the first curved portion 23 may be provided in two, and the two first curved portions 23 are symmetrically and smoothly connected to two opposite sides of the first planar portion 21. The connection structure between the first curved portion 23 and first planar portion 21 has been described in detail above, and therefore will not be repeated here. The second planar portion 22 is provided in two, and the two second planar portions 22 are symmetrically and smoothly connected to the other sides of the two first curved portions 23, i.e., one second planar portion 22 is connected to one respective first curved portion 23. A gap is provided between two second planar portions 22, i.e., the sum of the width of two second planar portions 22 is less than the width of the first planar portion 21, so that the mechanical arm of the lamination system can slide within the gap, and the lamination process between the cover plate 2 and the display panel is completed. The width of the two second planar portions 22 in the foregoing exemplary embodiment is the same. It is noted that, the width of the second planar portions 22 may be different.

In this case, among three planar regions and two curved regions formed after the display panel 1 is laminated to the cover plate 2, one planar region is laminated to the first planar portion 21 of the cover plate 2, and the length of the planar region is substantively equal to the length of the first planar portion 21 and the width of the planar region is substantively equal to the width of the first planar portion 21. The other two planar regions are laminated to the second planar portions 22 of the cover plate 2, and the length of the two planar regions is substantively equal to the length of the second planar portion 22 and the width of the two planar regions is substantively equal to the width of the second planar portion 22. The two curved regions are laminated to two first curved portions 23 of cover plate 2 respectively, and the length of the two curved regions is substantively equal to the length of the first curved portions 23 and the width of the two curved regions is substantively equal to the width of the first curved portions 23. The two curved regions are bent to form a semi-circular arc.

Similarly, in order to correspond to the foregoing cover plate 2, referring to FIG. 10, the first cambered support portion 3b of the support plate 3 is provided in two, and the two first cambered support portions 3b are correspondingly connected to two opposite sides of the first straight support portion 3a. The second straight support portion 3c of the support plate 3 is provided in two, and the two second straight support portions 3c are correspondingly connected to the other opposite sides of the two first cambered support portions 3b.

The support plate may further be provided in structure of a double-plate. The first layer 31 may further include a fifth part 315 and a sixth part 316. The fifth part 315 is connected to the third part 313, the fifth part 315 forms the other first cambered support portion 3b, and the thickness of the fifth part 315 is equal to the thickness of the second part 312. The sixth part 316 is connected to the fifth part 315, and the thickness of the sixth part 316 is equal to the thickness of the third part 313. The support plate may further include a fourth layer 34. The fourth layer 34 is provided on one side of the sixth part 316 away from the display panel, and forms the other second straight support portion 3c with the sixth part 316. The modulus of the fourth layer 34 is greater than the modulus of the first layer 31.

Specifically, the support plate may include the first layer 31, the second layer 32, the third layer 33 and the fourth layer 34. The first layer 31 may include the first part 311, the second part 312, the third part 313, the fifth part 315 and the sixth part 316 interconnected. The thickness of the second part 312 is equal to the thickness of the fifth part 315, and the thickness of the first part 311, the thickness of the third part 313 is equal to the thickness of the sixth part 316. The thickness of the first part 311 is less than the thickness of the second part 312.

The second part 312 forms one first cambered support portion 3b, and is laminated to one side of the display panel away from one of the first curved portions. The fifth part 315 forms the other first cambered support portion 3b, and is laminated to one side of the display panel away from the other first curved portion. The second layer 32 is provided on one side of the first part 311 away from the display panel, the first part 311 and the second layer 32 form one second straight support portion 3c, the first part 311 is laminated to one side of the display panel away from second planar portion, and the second layer 32 is laminated to the first part 311 away from the second planar portion. The third layer 33 is provided on one side of the third part 313 away from the display panel, the third part 313 and the third layer 33 form the first straight support portion 3a, the third part 313 is laminated to one side of the display panel away from the first planar portion, and the third layer 33 is laminated to one side of the third part 313 away from the first planar portion. The fourth layer 34 is provided one side of the sixth part 316 away from the display panel, the sixth part 316 and the fourth layer 34 form the other second straight support portion 3c, the sixth part 316 is laminated to one side of the display panel away from the second planar portion, and the fourth layer 34 is laminated to one side of the sixth part 316 away from the second planar portion.

The width of the first part 311 is equal to the width of the sixth part 316, the width of the second part 312 is equal to the width of the fifth part 315, and the width of the first part 311 is less than the width of the third part 313. The width of the second layer 32 is less than the width of the third layer 33, and the width of the second layer 32 is equal to the width of the fourth layer 34.

In addition, in some other exemplary embodiments of the present disclosure, a plurality of fourth layers 34 may be provided, the fourth layers are provided in the form of strips, the plurality of fourth layer 34 are provided parallel to each other on one side of the sixth part 316 away from the display panel 1. In this case, the width of a respective fourth layer 34 is relatively small, and two adjacent fourth layers 34 may be provided at intervals, or may not be provided at intervals.

It is noted that, the foregoing first layer 31, second layer 32, third layer 33 and fourth layer 34 are only used to refer to different structural parts, and are not used to limit the stacking sequence of the film layers.

Further, the exemplary embodiment of the present disclosure further provides a lamination system for the lamination of the display device according to any one embodiment of the above. The lamination system may include a stage, a carrier film 8, a clamp portion 9, a mechanical arm 10, a slider 11 and the like. The stage may be configured to fix the cover plate 2. The carrier film 8 may be configured to laminate the support plate 3 and the display panel 1 in sequence. The clamp portion 9 may be configured to clamp two opposite sides of the carrier film 8. The slider 11 is connected to one side of the mechanical arm 10, the carrier film 8 surrounds outside the slider 11, and the mechanical arm 10 is configured to drive the slider 11 to move so that the display panel 1 is laminated to the cover plate 2.

In the exemplary embodiment of the present disclosure, one end of the mechanical arm 10 may be fixed on the stage, and the other end of the mechanical arm 10 is connected to the slider 11, so that the mechanical arm 10 can drive the slider 11 to move. The lamination system may further includes a clamping arm (not shown), one end of the clamping arm is fixed on the stage, and the other end of the clamping arm is connected to the clamp portion 9. The clamping arm is provided in two, and the corresponding clamp portion 9 is also provided in two, the two clamping arms and the two clamp portions 9 being in a one-to-one corresponding relation. The two clamp portions 9 clamp two opposite ends of the carrier film 8 respectively. The clamping arms can drive the clamp portions 9 to move.

It is noted that, two opposite ends of the carrier film 8 refer to two opposite ends in the second direction when the carrier film 8 is in an unfolded state.

In the present exemplary embodiment, the material of the carrier film 8 may be high molecular polyethylene polypropylene fibers (PPF).

In order to correspond to the cover plate 2 of the foregoing three types of exemplary embodiments, the slider 11 may also be provided in three structures, and the structures of the slider 11 will be described in detail below.

The slider 11 may be provided in rectangle shape. Specifically, corresponding to the cover plate 2 shown in FIG. 3, referring to FIG. 5, the slider 11 may include a first flat surface, a second flat surface and a first cambered surface. The second flat surface and the first flat surface are provided oppositely and in parallel, and the length of the second flat surface may be equal to the length of the first flat surface and the width of the second flat surface may be equal to the width of the first flat surface. The first cambered surface is smoothly connected between the first flat surface and the second flat surface, i.e., one end of the first cambered surface is smoothly connected to one end of the first flat surface, and the other end of the first cambered surface is smoothly connected to one end of the second flat surface. The first cambered surface may be a semi-circular arc surface, or may be a semi-elliptical arc surface, a semi-parabolic arc surface, etc.

The lamination system may further include a bump 111. The bump 111 is provided on the second flat surface, and there is a first gap 112 between the bump 111 and the second flat surface. One end of the carrier film 8 can pass through the first gap 112.

The cover plate 2 is fixed on the stage, and the first planar portion 21 of the cover plate 2 is closer to the stage than the second planar portion 22. When the clamp portion 9 clamps the carrier film 8 and pulls it toward the side of the second planar portion 22, the carrier film 8, the portion of which surrounds the second flat surface of the slider 11, may be pulled up under the pull of clamp portion 9, resulting in the second flat surface not being surrounded by the carrier film 8. In this case, the bump 111 and the first gap 112 are provided such that the carrier film 8 can pass through the first gap 112 to avoid the carrier film 8 being pulled up and not surrounding the second flat surface.

When the display panel 1 is laminated to the cover plate 2, the first flat surface is opposite to the first planar portion 21, and the first flat surface of the slider 11 presses the display panel 1, so that the display panel 1 is laminated to the first planar portion 21; the second flat surface is opposite to the second planar portion 22, and the second flat surface of the slider 11 presses the display panel 1, so that the display panel 1 is laminated to the second planar portion 22; and the first cambered surface is opposite to the first curved portion 23, and the first cambered surface of the slider 11 presses the display panel 1, so that the display panel 1 is laminated to the first curved portion 23.

Corresponding to the cover plate 2 shown in FIG. 6, referring to FIG. 11, the slider 11 may include the first flat surface, the second flat surface, the first cambered surface and the second cambered surface. The second flat surface and the first flat surface are provided oppositely and in parallel, and the length of the second flat surface may be equal to the length of the first flat surface, but the width of the second flat surface is different from the width of the first flat surface. The first cambered surface is smoothly connected between the first flat surface and the second flat surface, i.e., one end of the first cambered surface is smoothly connected to one end of the first flat surface, and the other end of the first cambered surface is smoothly connected to one end of the second flat surface. The first cambered surface is a semi-circular arc surface. The second cambered surface is smoothly connected to one side of the first flat surface away from the first cambered surface, and the second cambered surface may be a quarter circular arc surface, a quarter elliptic arc surface, a quarter parabolic arc surface, or a one third of a circular arc surface, etc.

The lamination system may further include the bump 111, the bump 111 is provided on the second flat surface, and there is the first gap 112 between the bump 111 and the second flat surface. One end of the carrier film 8 can pass through the first gap 112.

The cover plate 2 is fixed on the stage, and the first planar portion 21 of the cover plate 2 is closer to the stage than the second planar portion 22. When the clamp portion 9 clamps the carrier film 8 and pulls it toward the side of the second planar portion 22, the carrier film 8, the portion of which surrounds the second flat surface of the slider 11, may be pulled up under the pull of clamp portion 9, resulting in the second flat surface not being surrounded by the carrier film 8. In this case, the bump 111 and the first gap 112 are provided such that the carrier film 8 can pass through the first gap 112 to avoid the carrier film 8 being pulled up and not surrounding the second flat surface.

When the display panel 1 is laminated to the cover plate 2, the first flat surface is opposite to the first planar portion 21, and the first flat surface of the slider 11 presses the display panel 1, so that the display panel 1 is laminated to the first planar portion 21; the second flat surface is opposite to the second planar portion 22, and the second flat surface of the slider 11 presses the display panel 1, so that the display panel 1 is laminated to the second planar portion 22; the first cambered surface is opposite to the first curved portion 23, and the first cambered surface of the slider 11 presses the display panel 1, so that the display panel 1 is laminated to the first curved portion 23; and the second cambered surface is opposite to the second curved portion 24, and the second cambered surface of the slider 11 presses the display panel 1, so that the display panel 1 is laminated to the second curved portion 24.

Corresponding to the cover plate 2 shown in FIG. 9, referring to FIG. 12, the slider 11 may include the first flat surface, two second flat surfaces and two first cambered surfaces. The two first cambered surfaces are symmetrically and smoothly connected between the first flat surface and the second flat surface, one end of each first cambered surface being smoothly connected to one end of the first flat surface, and the other end of each first cambered surface being smoothly connected to one end of the second flat surface. The two second flat surfaces are symmetrically and smoothly connected to the two first cambered surfaces. The second flat surface and the first flat surface are provided oppositely and in parallel, the length of the second flat surface may be equal to the length of the first flat surface, but the width of the second flat surface is different from the width of the first flat surface. The first cambered surface is smoothly between the first flat surface and the second flat surface, i.e., one end of the first cambered surface is smoothly connected to one end of the first flat surface, and the other end of the first cambered surface is smoothly connected to one end of the second flat surface. The first cambered surface is a semi-circular arc surface.

The lamination system may further include the bump 111. The bump 111 is provided on the second flat surface, there are two first gaps 112 between the bump 111 and the second flat surface, and there are also two second gaps 113 on the bump 111, where the extending direction of the second gap 113 intersects the extending direction of the first gap 112, for example, it may be perpendicular. The two second gaps 113 and the two first gaps 112 correspondingly communicate, one end of the carrier film 8 can pass through one first gap 112 and one second gap 113, and the other end of the carrier film 8 can pass through the other first gap 112 and the other second gap 113. In addition, in other exemplary embodiments of the present disclosure, the foregoing two first gaps 112 may be communicated to form one first gap 112, the two ends of the carrier film 8 can penetrate through the two sides of the first gap 112, respectively. The second gap 113 may also be provided in one with relatively wide width which may accommodate two layers of carrier film 8 at the same time and ensures that two layers of carrier film 8 do not interfere with each other when moving.

The cover plate 2 is fixed on the stage, and the first planar portion 21 of the cover plate 2 is closer to the stage than the second planar portion 22. When the clamp portion 9 clamps the carrier film 8 and pulls it toward the side of the second planar portion 22, the carrier film 8, the portion of which surrounds the second flat surface of the slider 11, may be pulled up under the pull of the clamp portion 9, resulting in the second flat surface not being surrounded by the carrier film 8. In this case, the bump 111, the first gap 112, and the second gap 113 are provided such that the carrier film 8 can pass through the first gap 112 and the second gap 113 to avoid the carrier film 8 being pulled up and not surrounding the second flat surface.

When the display panel 1 is laminated to the cover plate 2, the first flat surface is opposite to the first planar portion 21, and the first flat surface of the slider 11 presses the display panel 1, so that the display panel 1 is laminated to the first planar portion 21; the second flat surface is opposite to the second planar portion 22, and the second flat surface of the slider 11 presses the display panel 1, so that the display panel 1 is laminated to the second planar portion 22; and the first cambered surfaces are opposite to the first curved portions 23, and the first cambered surfaces of the slider 11 press the display panel 1, so that the display panel 1 is attached to the first curved portions 23.

In the display device of the present disclosure, the cover plate includes the first planar portion, the first curved portion, and the second planar portion connected in sequence, the second planar portion being parallel to the first planar portion, and the first curved portion being provided as an arc, and the cover plate being a surround-shaped cover plate; the support plate includes the first straight support portion, the first cambered support portion and the second straight support portion connected in sequence, the modulus of the first cambered support portion being smaller than the modulus of the first straight support portion and being smaller than the modulus of the second straight support portion; the first straight support portion is laminated to one side of the display panel away from the first planar portion, and the second straight support portion is laminated to one side of the display panel away from the second planar portion, so that the support plate has sufficient strength to achieve the effect of supporting the display panel; and the first cambered support portion is laminated to one side of the display panel away from the first curved portion, causing the support plate to have sufficient flexibility to prevent the support plate from warping and bulging easily during bending, so that warping and bulging of the display panel is avoided, the distance between two opposite planar portions of the display panel may not increase after profiling, and the slider, the carrier film, the support plate and the display panel can successfully enter into the cover plate. In addition, the display panel and the slider are tightly laminated, so that it is easy for the cover plate to be laminated with display panel when the slider drives the display panel to move in the lamination process, and in the lamination process of the cover plate and the display panel, bubbles are not easily generated nor wrinkles may be produced.

Further, the exemplary embodiment of the present disclosure further provides a lamination method in which the display device according to any one embodiment of the above is formed by laminating with the lamination system according to any one embodiment of the above. Referring to FIG. 13, the lamination method may include the following steps.

Step S10, adhering the support plate 3 and the display panel 1 in sequence on one surface of the carrier film 8; and forming the first adhesive layer 4 on one side of the display panel 1 away from the carrier film 8.

Step S20, surrounding the carrier film 8 outside the slider 11, and clamping, by the clamp portion 9, two opposite ends of the carrier film 8 for profiling of the display panel.

Step S30, driving, by the mechanical arm 10, the slider 11 to move to the accommodation space of the cover plate 2 along the third direction.

Step S40, driving, by the mechanical arm 10, the slider 11 to move along the fourth direction, so that the display panel 1 is in contact with the first curved portion, and driving, by the mechanical arm 10, the slider 11 to slide along the first curved portion to complete the lamination between the display panel 1 and the first curved portion.

Step S50, driving, by the mechanical arm 10, the slider 11 to move along the direction perpendicular to the first planar portion to complete the lamination between the display panel 1 and the first planar portion.

The lamination method will be described in detail below.

It is noted that, “the carrier film 8 surrounds outside the slider 11” refers to that the carrier film 8 surrounds substantially three surfaces of the slider 11 without completely surrounding the slider 11.

The support plate 3 is laminated on one surface of the carrier film 8, the third adhesive layer 7 is laminated on one surface of the support plate 3 away from the carrier film 8, the protective layer 5 is laminated on one surface of the third adhesive layer 7 away from the carrier film 8, the second adhesive layer 6 is coated on one surface of the protective layer 5 away from the carrier film 8, the display panel 1 is laminated on one surface of the second adhesive layer 6 away from the carrier film 8, and the first adhesive layer 4 is coated on one surface of the display panel 1 away from the carrier film 8.

The adhesive force between the support plate 3 and the protective layer 5 is 12 N/25 mm², i.e., the adhesive force of the third adhesive layer 7 is 12 N/25 mm². The adhesive force between the support plate 3 and the carrier film 8 is 2000 gf/inch, and after UV sticky reduction, the adhesive force<10 gf/inch. The adhesive force between the support plate 3 and the carrier film 8 is less than the adhesive force between the support plate 3 and the protective layer 5, so that after the lamination of the display panel 1 is completed, the support plate 3 will not be peeled off the protective layer 5 when the carrier film 8 is peeled off the support plate 3,.

Referring to FIGS. 5, 11, and 12, the carrier film 8 is placed around the outside of the slider 11, and the carrier film 8 is passed through the first gap 112, or the carrier film 8 is passed through the first gap 112 and the second gap 113; and the opposite ends of the carrier film 8 are clamped through the clamp portion 9, so that the carrier film 8 is tensioned for profiling the display panel 1.

The mechanical arm 10 drives the slider 11 to move along the third direction, so that the slider 11 and each film layer surrounding thereon move to the accommodation space of the cover plate 2.

With regard to the cover plate 2 shown in FIG. 3, referring to FIG. 14, the arrow direction in the figure is the moving direction, and at this time, two clamp portions 9 are both in the tension position, so that the carrier film 8 is in the tension state. The mechanical arm 10 drives the slider 11 to move toward the side close to the first curved portion 23 until the display panel 1 is laminated to the first curved portion 23 to form the structure shown in FIG. 15. The arrow direction in the FIG. 15 is the moving direction, and at this time, the clamp portion 9 at the lower part is in the tension position while the clamp portion 9 at the upper part is in the slack position, so that the lower half of the carrier film 8 is in the tension state, while the upper half of the carrier film 8 is in the relax state, avoiding defects such as bubbles, wrinkles and the like during the subsequent lamination of the lower half of the carrier film 8. The mechanical arm 10 drives the slider 11 to move downward along the first curved portion 23 by about a quarter circular arc, so that the display panel 1 is laminated to the lower half of the first curved portion 23, and then the mechanical arm 10 drives the slider 11 to continue moving downward, i.e., the mechanical arm 10 drives the slider 11 to move toward to the side close to the first planar portion 21 until the display panel 1 is laminated to the first planar portion 21. And then, the clamp portion 9 at the lower part is in the slack position, while the clamp portion 9 at the upper part is in the tension position, so that the lower half of the carrier film 8 is in the relax state, while the upper half of the carrier film 8 is in the tension state, avoiding defects such as bubble, wrinkles and the like during the subsequence lamination of the upper half of the carrier film 8. The mechanical arm 10 drives the slider 11 to move upward along the first curved portion 23 by about half circular arc, so that the display panel 1 is completely laminated to the first curved portion 23, and then the mechanical arm 10 drives slider 11 to continue moving upward, i.e., the mechanical arm 10 drives the slider 11 to move toward the side close to the second planar portion 22 until the display panel 1 is laminated to the second planar portion 22 to form the structure shown in FIG. 16. Finally, the mechanical arm 10 drives the slider 11 to exit the accommodation space of the cover plate 2. Of course, it is also possible for the mechanical arm 10 to move upward along the first curved portion 23 to complete the lamination between the display panel 1 and the upper half of the first curved portion 23, and the lamination between the display panel 1 and the second planar portion 22; and then move downward along the first curved portion 23 to complete the complete the lamination between the display panel 1 and the entire first curved portion 23, and the lamination between the display panel 1 and the first planar portion 21.

With regard to the cover plate 2 shown in FIG. 6, referring to FIG. 17, the arrow direction in the figure is the moving direction, and at this time, two clamp portions 9 are both in the tension position, so that the entire carrier film 8 is in the tension state. The mechanical arm 10 drives the slider 11 to move toward the side close to the first curved portion 23 until the display panel 1 is laminated to the first curved portion 23 to form the structure shown in FIG. 18. The arrow direction in the FIG. 18 is the moving direction, at this time, the clamp portion 9 at the lower part is in the tension position, while the clamp portion 9 at the upper part is in the slack position, so that the lower half of the carrier film 8 is in the tension state, while the upper half is in the relax state, avoiding defects such as bubbles, wrinkles and the like during the subsequent lamination of the lower half of the carrier film 8. The mechanical arm 10 drives the slider 11 to move downward along the first curved portion 23 by about a quarter circular arc, so that the display panel 1 is laminated to the lower half of the first curved portion 23. And then, the clamp portion 9 at the lower part is in the slack position, while the clamp portion 9 at the upper part is in the tension position, so that the lower half of the carrier film 8 is in the relax state, while the upper half of the carrier film 8 is in the tension state, avoiding defects such as bubbles, wrinkles and the like during the subsequence lamination of the upper half of the carrier film 8. The mechanical arm 10 drives the slider 11 to move upward along the first curved portion 23 by about half circular arc, so that the display panel 1 is completely laminated to the first curved portion 23, and then the mechanical arm 10 drives the slider 11 to continue moving upward, i.e., the mechanical arm 10 drives the slider 11 to move toward the side close to the second planar portion 22 until the display panel 1 is laminated to the second planar portion 22 to form the structure shown in FIG. 19. The arrow direction in FIG. 19 is the moving direction, and at this time, the clamp portion 9 at the lower part is in the tension position, while the clamp portion 9 at the upper part is in the slack position, so that the lower half of the carrier film 8 is in the tension state, while the upper half of the carrier film 8 is in the relax state, avoiding defects such as bubbles, wrinkles and the like during the subsequence lamination of the lower half of the carrier film 8. The mechanical arm 10 drives the slider 11 to move toward the side close to the first planar portion 21 until the display panel 1 is laminated to the first planar portion 21 to form the structure shown in FIG. 20. The arrow direction in FIG. 20 is the moving direction, and the mechanical arm 10 drives the slider 11 to move toward the side close to the second curved portion 24 to form the structure shown in FIG. 21. The arrow direction in FIG. 21 is the moving direction, and then, the mechanical arm 10 drives the slider 11 to move upward along the second curved portion 24 by about a quarter circular arc until the display panel 1 is completely laminated to the second curved portion 24 to form the structure shown in FIG. 22. Finally, the mechanical arm 10 drives the slider 11 to exit the accommodation space of the cover plate 2.

With regard to the cover plate 2 shown in FIG. 9, referring to FIG. 23, the arrow direction in the figure is the moving direction, and at this time, two clamp portions 9 are both in the tension position, so that the entire carrier film 8 is in the tension state. The mechanical arm 10 drives the slider 11 to move upward until the display panel 1 is laminated to the upper edge of the first curved portion 23 on the left to form the structure shown in FIG. 24. The arrow direction in FIG. 24 is the moving direction, and at this time, the clamp portion 9 on the right is in the tension position, while the clamp portion 9 on the left is in the slack position, so that the right half of the carrier film 8 is in the tension state, while the left half is in the relax state. The mechanical arm 10 drives the slider 11 to move downward along the first curved portion 23 by about half circular arc, so that the display panel 1 is completely laminated to the first curved portion 23 on the left, and then the mechanical arm 10 drives the slider 11 to continue moving downward, i.e., the mechanical arm 10 drives the slider 11 to move toward the side close to the first planar portion 21 until the display panel 1 is laminated to the first planar portion 21 to form the structure shown in FIG. 25. The arrow direction in FIG. 25 is the moving direction, and the mechanical arm 10 drives the slider 11 to move upward along the first curved portion 23 on the right by half circular arc, so that the display panel 1 is completely laminated to the first curved portion 23 on the right. And then two clamp portions 9 are both in the tension position, so that the entire carrier film 8 is in the tension state, and the mechanical arm 10 drives the slider 11 to continue moving upward, i.e., the mechanical arm 10 drives the slider 11 to move toward the side close to the second planar portion 22 until the display panel 1 is laminated to the second planar portion 22 to form the structure shown in FIG. 26. Finally, the mechanical arm 10 drives the slider 11 to exit the accommodation space of the cover plate 2.

It is noted that, although the various steps of the lamination method in the present disclosure are described in a specific order in the accompanying drawings, it does not require or imply that the steps must be executed in the specific order, or that all the steps shown must be executed to achieve a desired result. Additionally or alternatively, certain steps may be omitted, multiple steps may be combined into one step for execution, and/or one step may be decomposed into multiple steps for execution, etc.

Other embodiments of the present disclosure will readily occur to those skilled in the art upon consideration of the description and practice of the application disclosed here. This application is intended to cover any variations, uses, or adaptations of the present disclosure that follow the general principles of the present disclosure and include well-known knowledge or common technical means in the art not disclosed by the present disclosure. The description and embodiments are to be regarded as exemplary only, with the true scope and spirit of the disclosure being indicated by the appended claims.

1. A display device, comprising:
a cover plate comprising at least a first planar portion, a second planar portion and a first curved portion, wherein the first curved portion is smoothly connected between the first planar portion and the second planar portion; the second planar portion is parallel to the first planar portion; and the first planar portion, the second planar portion and the first curved portion enclose an accommodation space;
a display panel in the accommodation space; and
a support plate comprising at least a first straight support portion, a first cambered support portion and a second straight support portion connected in sequence, wherein modulus of the first cambered support portion is less than modulus of the first straight support portion, and the modulus of the first cambered support portion is less than modulus of the second straight support portion;
wherein the first straight support portion is laminated to one surface of the display panel away from the cover plate, corresponding to the first planar portion, the first cambered support portion is laminated to the surface of the display panel away from the cover plate, corresponding to the first curved portion, and the second straight support portion is laminated to the surface of the display panel away from the cover plate, corresponding to the second planar portion.

2. The display device according to claim 1, wherein the support plate comprises:
a first layer comprising at least a first part, a second part and a third part connected in sequence, wherein the second part forms the first cambered support portion;
at least one second layer on one side of the first part away from the display panel, and forming the second straight support portion with the first part, wherein modulus of the first layer is less than modulus of the second layer; and
at least one third layer on one side of the third part away from the display panel, and forming the first straight support portion with the third part, wherein the modulus of the first layer is less than the modulus of the third layer.

3. The display device according to claim 2, wherein a thickness of the second part is greater than a thickness of the first part, and the thickness of the second part is greater than a thickness of the third part.

4. The display device according to claim 3, wherein the thickness of the second part is equal to a sum of the thickness of the first part and a thickness of the second layer, and the thickness of the second part is equal to a sum of the thickness of the third part and a thickness of the third layer.

5. (canceled)

6. The display device according to claim 1, wherein the first curved portion extents along a first direction; and a width of the second planar portion in a second direction is equal to or less than a width of the first planar portion in the second direction, the second direction being perpendicular to the first direction.

7. The display device according to claim 6, wherein a width of the first straight support portion in the second direction is equal to or less than a width of the second straight support portion in the second direction.

8. The display device according to claim 2, wherein the cover plate further comprises:
a second curved portion smoothly connected to one side of the first planar portion away from the first curved portion, wherein the second curved portion and the first curved portion are bent to a same surface of the first planar portion, and an orthographic projection of the second curved portion on a first datum plane is an arc, the first datum plane being perpendicular to a extending direction of the first curved portion.

9. The display device according to claim 8, wherein the support plate further comprises:
a second cambered support portion connected to one side of the first straight support portion away from the first cambered support portion, and laminated to the surface of the display panel away from the cover plate, corresponding to the second curved portion, wherein modulus of the second cambered support portion is less than the modulus of the first straight support portion, and the modulus of the second cambered support portion is less than the modulus of the second straight support portion.

10. The display device according to claim 9, wherein the first layer further comprises:
a fourth part connected to the third part, wherein the fourth part forms the second cambered support portion, and a thickness of the fourth part is equal to a thickness of the second part.

11. The display device according to claim 2, wherein the first curved portion is provided in two, the two first curved portions being correspondingly and smoothly connected to two opposite sides of the first planar portion; and the second planar portion is provided in two, the two second planar portions being correspondingly and smoothly connected to another opposite sides of the two first curved portions, and a gap being provided between the two second planar portions.

12. The display device according to claim 11, wherein the first cambered support portion is provided in two, the two first cambered support portions being correspondingly connected to two opposite sides of the first straight support portion; and the second straight support portion is provided in two, the two second straight support portions being correspondingly connected to another opposite sides of the two first cambered support portions.

13. The display device according to claim 12, wherein the first layer further comprises:
a fifth part connected to the third part, wherein the fifth part forms the first cambered support portion, and a thickness of the fifth part is equal to a thickness of the second part; and
a sixth part connected to the fifth part, wherein a thickness of the sixth part is equal to a thickness of the third part; and
wherein the support plate further comprises:
at least one fourth layer on one side of the sixth part away from the display panel, and forming the second straight support portion with the sixth part, wherein modulus of the fourth layer is greater than the modulus of the first layer.

14. The display device according to claim 1, wherein material of the first straight support portion and the second straight support portion comprises stainless steel, and material of the first cambered support portion comprises foam.

15. The display device according to claim 1, further comprising:
a first adhesive layer adhered between the cover plate and the display panel;
a protective layer between the display panel and the support plate;
a second adhesive layer adhered between the display panel and the protective layer; and
a third adhesive layer adhered between the protective layer and the support plate.

16. (canceled)

17. A lamination system for a lamination of a display device, wherein the display device comprises:
a cover plate comprising at least a first planar portion, a second planar portion and a first curved portion, wherein the first curved portion is smoothly connected between the first planar portion and the second planar portion; the second planar portion is parallel to the first planar portion; and the first planar portion, the second planar portion and the first curved portion enclose an accommodation space;
a display panel in the accommodation space; and
a support plate comprising at least a first straight support portion, a first cambered support portion and a second straight support portion connected in sequence, wherein modulus of the first cambered support portion is less than modulus of the first straight support portion, and the modulus of the first cambered support portion is less than modulus of the second straight support portion;
wherein the first straight support portion is laminated to one surface of the display panel away from the cover plate, corresponding to the first planar portion, the first cambered support portion is laminated to the surface of the display panel away from the cover plate, corresponding to the first curved portion, and the second straight support portion is laminated to the surface of the display panel away from the cover plate, corresponding to the second planar portion; and
the lamination system comprises:
a stage configured to fix the cover plate;
a carrier film configured to laminate the support plate and the display panel in sequence;
a clamp portion configured to clamp two opposite ends of the carrier film;
a slider, the carrier film surrounding outside the slider; and
a mechanical arm, with one end connected to the slider, wherein the mechanical arm is configured to drive the slider to move so that the display panel is laminated to the cover plate.

18. The lamination system according to claim 17, wherein the slider comprises:
a first flat surface;
a second flat surface being in parallel with the first flat surface; and
a first cambered surface smoothly connected between the first flat surface and the second flat surface.

19. The lamination system according to claim 18, further comprising:
a bump provided on the second flat surface, with a first gap between the bump and the second flat surface, wherein one end of the carrier film is passable through the first gap.

20. The lamination system according to claim 19, wherein the slider further comprises:
a second cambered surface smoothly connected to one side of the first flat surface away from the first cambered surface.

21. The lamination system according to claim 19, wherein
the first cambered surface is provided in two, and the second flat surface is provided in two, the two first cambered surfaces being correspondingly and smoothly connected between the first flat surface and the two second flat surfaces;
the bump is provided on the two second flat surfaces; and
the first gap is provided in two, and two second gaps are provided on the bump, an extending direction of the two second gaps intersecting with an extending direction of the two first gaps, the two second gaps correspondingly communicating with the two first gaps, one end of the carrier film being passable through one first gap of the two first gaps and one second gap of the two second gaps.

22. A lamination method, wherein a display device is formed by a lamination system using the lamination method, wherein
the display device comprises:
a cover plate comprising at least a first planar portion, a second planar portion and a first curved portion, wherein the first curved portion is smoothly connected between the first planar portion and the second planar portion; the second planar portion is parallel to the first planar portion; and the first planar portion, the second planar portion and the first curved portion enclose an accommodation space;
a display panel in the accommodation space; and
a support plate comprising at least a first straight support portion, a first cambered support portion and a second straight support portion connected in sequence, wherein modulus of the first cambered support portion is less than modulus of the first straight support portion, and the modulus of the first cambered support portion is less than modulus of the second straight support portion;
wherein the first straight support portion is laminated to one surface of the display panel away from the cover plate, corresponding to the first planar portion, the first cambered support portion is laminated to the surface of the display panel away from the cover plate, corresponding to the first curved portion, and the second straight support portion is laminated to the surface of the display panel away from the cover plate, corresponding to the second planar portion;
the lamination system comprises:
a stage configured to fix the cover plate;
a carrier film configured to laminate the support plate and the display panel in sequence;
a clamp portion configured to clamp two opposite ends of the carrier film;
a slider, the carrier film surrounding outside the slider; and
a mechanical arm, with one end connected to the slider, wherein the mechanical arm is configured to drive the slider to move so that the display panel is laminated to the cover plate; and
the lamination method comprises:
adhering a support plate and a display panel in sequence on one surface of a carrier film, and forming a first adhesive layer on one side of the display panel away from the carrier film;
surrounding the carrier film outside a slider, and clamping, by a clamp portion, two opposite ends of the carrier film for profiling of the display panel;
driving, by a mechanical arm, the slider to move along a third direction to an accommodation space of a cover plate;
driving, by the mechanical arm, the slider to move along a fourth direction, so that the display panel is in contact with a first curved portion, and driving, by the mechanical arm, the slider to slide along the first curved portion to complete the lamination between the display panel and the first curved portion; and
driving, by the mechanical arm, the slider to move along a direction perpendicular to the first planar portion to complete the lamination between the display panel and the first planar portion or between the display panel and the second planar portion.
